(19) United States
(12) Patent Application Publication
(10) Pub. No.: US 2017/0220289 A1
(43) Pub. Date: Aug. 3, 2017

(54) TECHNIQUES FOR REMEDIATING NON-CONFORMING STORAGE SYSTEM CONFIGURATIONS

(71) Applicant: NETAPP, INC., Sunnyvale, CA (US)

(72) Inventors: Rohit Arora, Raleigh, NC (US); Deepak Thomas, Apex, NC (US); Dan Sarisky, Cary, NC (US)

(21) Appl. No.: 15/010,544

(22) Filed: Jan. 29, 2016

(51) Int. Cl. G06F 3/06

(52) U.S. Cl. CPC G06F 3/0634; G06F 3/0604; G06F 3/0635; G06F 3/067; G06F 3/0685; G06F 3/0689

(57) ABSTRACT

Various embodiments are generally directed an apparatus and method for determining a profile for an application, the profile to specify a setting for one or more storage services provided by a storage system, determining whether settings for provided storage services for the application conform to the profile. Further and in response to determining one or more of the provided storage services is non-conforming, performing a remediation operation to correct non-conforming storage services, and in response to determining the provided storage services are conforming storage services, providing an indication indicating the provided storage services are conforming to the profile.

### TECHNICAL FIELD

Embodiments described herein generally relate to performing a remediation operation to correct non-conforming storage system configurations.

### BACKGROUND

Storage systems may store and provide information to one or more computing systems in a network, such as a storage area network (SAN) or network-attached storage (NAS). More specifically, a computing system including one or more applications may write information to a storage system and read information from the storage system over one or more connections, such as networking connections. These storage systems may include one or more storage devices, such as disks, configured as an aggregate to store large amounts of the information and data. In some instances, the one or more applications may require a particular profile configuration to support read/writes and performance objectives. Thus, embodiments may be directed to ensuring these requirements are met for the one or more applications.

### BRIEF DESCRIPTION OF THE DRAWINGS

Embodiments described herein are illustrated by way of example, and not by way of limitation, in the figures of the accompanying drawings in which like reference numerals refer to similar elements.

FIG. 1A illustrates an example embodiment of a storage computing system.

FIG. 1B illustrates a second example embodiment of a storage computing system.

FIG. 2 illustrates an example first logic flow to perform one or more remediation operations.

FIGS. 3A/3B illustrates an example first block diagram for performing a remediation operation.

FIGS. 4A/4B illustrates an example second block diagram for performing a remediation operation.

FIGS. 5A/5B illustrates an example third block diagram for performing a remediation operation.

FIG. 6 illustrates an exemplary embodiment of a logic flow.

FIG. 7 illustrates an exemplary embodiment of a computing system.

FIG. 8 illustrates an embodiment of a first computing architecture.

### DETAILED DESCRIPTION

Various embodiments are directed to systems, devices, apparatuses, methods and so forth to provide policy and profile based management and monitoring in a storage system. In some instances, a storage system may be a large storage environment having many resources to store large amounts of data. As will be discussed in more detail below, these resources may include one or more computing and storage devices, such as servers, aggregates, physical storage devices, networking interconnects, and so forth.

Customers or users of the storage system may configure and establish one or more service level objectives (SLOs) establishing specific performance requirements and features to be provided by the storage system. These features may include one or more storage services and settings for these storage services. Further, the storage services to be provided by the storage system for a specific user and/or application may be specified in a profile. For any number of reasons, at any given point in time, one or more of the performance and feature requirements may not be met. Thus, embodiments are directed to determine when a storage system provide storage services is non-compliant with respect to the service level objectives and the specified storage service's settings in the profile.

For example, embodiments may include determining a profile for an application utilizing a storage system. As previously mentioned, the profile may specify a for one or more storage services provided by the storage system. In some embodiments, the profile may be determined by a server or controller of the storage system by performing a scan, poll or read operation of the storage system including data servers and aggregates storing information and data. In some embodiments, the profile for the application may be determined or based on the profile of a data structure, such as virtual volume (vVol) including a file or LUN for the application.

Embodiments may also include determining whether provided storage services for the application conform to the profile for the application. The provided storage services may be determined during a scan, poll, or read operation performed by a server and based on the profiles of an aggregate and/or flexible volume on which the application and data structure are stored. For example, the server may determine whether the provided storage services are the same or match the required storage services as specified by the profile associated with the data structure and application. If the settings for the storage services are the same, then the provided storage service conform to the profile for the application. However, if the settings for the storage services do not match the required storage services, then they do not conform and a remediation operation may be performed.

More specifically, embodiments may include determining which of the one or more provided storage services is non-conforming and perform a remediation operation to correct the non-conforming storage services. The remediation operation may include changing a setting for each non-conforming storage service to conform to the profile for the application. In another example, the remediation operation may include moving one or more data structures associated with the application from a first flexible volume to a second flexible volume, the second flexible volume having settings for storage services conforming to the profile. In a third example, the remediation operation may include moving a flexible volume associated with the application from a first aggregate to a second aggregate, the second aggregate having settings for the storage services conforming to the profile. Embodiments are not limited to these examples. For example, the remediation may include generating a new flexible volume for a group of data structures having the same storage service requirements. In embodiments, the storage system may monitor and continue to ensure that profiles for applications are being met. These and other details will become more apparent in the following description.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

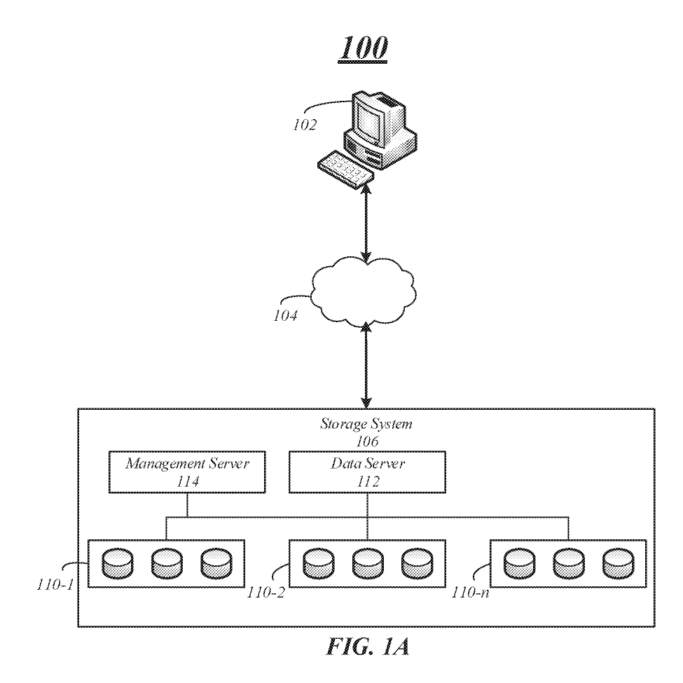

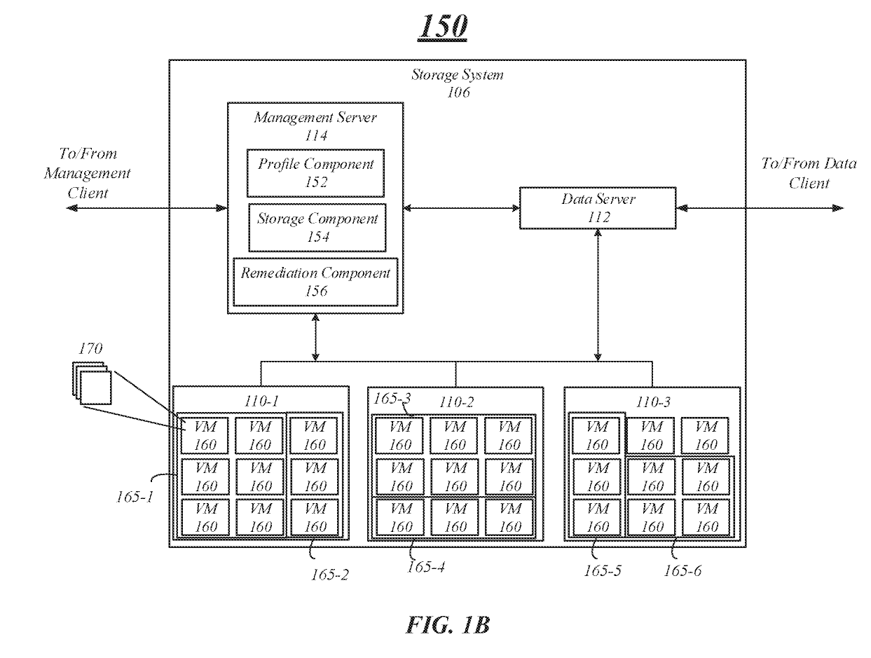

FIG. 1A illustrates a general overview of a system 100 including a storage system 106 coupled with a client 102 via a network 104 having one or more interconnects. The storage system 106 may include one or more aggregate 110 storage clusters having one or more storage devices which may be configured in a redundant array of independent disks (RAID) configuration. In various embodiments, computing system 100 may be a clustered storage system in a storage area network (SAN) environment or a network attached storage (NAS). For simplicity purposes, FIG. 1 only illustrates a single client 102 and a single storage system 106, however, computing system 100 may have any number of clients 102 and storage systems 106 to create or form a SAN or NAS environment.

The client 102 may be may be a general-purpose computer configured to execute one or more applications. Moreover, the client 102 may interact with the storage system 106 in accordance with a client/server model of information delivery. That is, the client 102 may request the services of the storage system 106, and the storage system 106 may return the results of the services requested by the host. For example, the client 102 may exchange information and data with the storage system 106 for storage on the aggregates 110 by exchanging packets over the network 104. The client 102 may issue packets including file-based access protocols, such as the Common Internet File System (CIFS) protocol or Network File System (NFS) protocol, over Transmission Control Protocol/Internet Protocol (TCP/IP) when accessing information in the form of files and directories. In addition, the client 102 may issue packets including block-based access protocols, such as the Small Computer Systems Interface (SCSI) protocol encapsulated over TCP (iSCSI) and SCSI encapsulated over Fibre Channel (FCP), when accessing information in the form of blocks. Embodiments are not limited to these examples.

In various embodiments, network 104 may include a point-to-point connection or a shared medium, such as a local area network. In some embodiments, network 104 may include any number of devices and interconnects such that client 102 may communicate with storage system 106. Illustratively, the computer network 104 may be embodied as an Ethernet network or a Fibre Channel (FC) network. The client 102 may communicate with the storage system 106 over the network 104 by exchanging discrete frames or packets of data according to pre-defined protocols, such as TCP/IP, as previously discussed.

Storage system 106 may include one or more computing devices that provide storage services relating to the storage and organization of information on storage devices of the aggregates 110. The aggregates 110-n, where n may be any positive integer, may include a number of storages device which can include hard disk drives (HDD) and direct access storage devices (DASD). In the same or alternative embodiments, the storage devices, may include non-volatile storages such as flash memory, etc. As such, the illustrative description of writeable storage device media includes magnetic media should be taken as an example only.

The storages disks within an aggregate 110 are typically organized as one or more groups, wherein each group may be operated as a Redundant Array of Independent (or Inexpensive) Disks (RAID). Most RAID implementations, such as a RAID-4 level implementation, enhance the reliability/integrity of data storage through the redundant writing of data “stripes” across a given number of physical disks in the RAID group, and the appropriate storing of parity information with respect to the striped data. An illustrative example of a RAID implementation is a RAID-4 level implementation, although it should be understood that other types and levels of RAID implementations may be used in accordance with the inventive principles described herein.

As will be discussed in more detail below, storage system 106 may include a number of elements and components to provide storage services to client 102. For example, storage system 106 may include a number of elements, components, and modules to implement a high-level module, such as a file system, to logically organize the information as a hierarchical structure of directories and files. These directories and files may be organized in one or more virtual volumes (vVol) on the storage devices of the aggregates 110 which is presented as a vVol datastore to the client 102 and encapsulated in a virtual machine (VM). Each aggregate may include a number of flexible volumes, such as NetApp's® FlexVol®, which may increase and decrease in size based on need. In some embodiments, each of the flexible volumes may be assigned or associated with one or more VMs based on particular storage services provided. Further and as will be discussed in more detail below, a virtual volume datastore may be associated with a storage container which may be mapped to one or more physical disks of an aggregate 110. A virtual volume datastore may be accessed by an application through an end point, such as a protocol endpoint (PE). The PE, whose operation depends on the storage protocol being used, includes but is not limited to NFS, iSCSI, Fibre Channel and FCoE. For NFS, the PE is simply an NFS mount point, and the virtual disks are files beneath that mount point, for example. Embodiments are not limited in this manner.

In some embodiments, each VM may require a particular level of service or have SLOs and require particular storage services which may be based on the SLO for the VM. These storage services may include vStorage APIs for Storage Awareness (VASA) Provider storage capability profile services and VMware VM Storage Policy services. Examples of storage services may include, but are not limited to auto grow, deduplication, compression, maximum throughput (IOPS and MBS), high availability, disk type, flash acceleration, protocol usage, and replication. Settings for each of these storages services may be configured for the flexible volume, the VM, and the virtual volumes.

In some embodiments, one or more VMs having the same particular storage service requirements may be assigned to a flexible volume meeting its requirements. However, one or more of these settings may be changed for any number of reasons creating a mismatch between the provided storage services for the flexible volume and the desired storage services for the VM and/or virtual volumes. Thus embodiments are directed to automatically determining when these mismatches occur and performing a remediation operation to correct the mismatches.

In some embodiments, the storage system 106 may include a data server 112 which may be a VMware® ESX® or ESXi host server to enable communication of application with an aggregate 110 and a VM. For example, the data server 112 connects to the virtual disks in a virtual volume datastore through the PE whose operation depends on the storage protocol being used. The data server 112 may make the PE visible to one or more applications for use on client 102, for example. Although FIG. 1A illustrates only a single data server 112, embodiments are not limited in this manner, and in most cases, embodiments may include a number of data servers 112 to enable communication of information between the client 102 and the aggregates 110.

The storage system 106 may also include a management server 114 to enable policy-based management and configuration of storage services. In some embodiments, the management server 114 may include a VASA provider and provide an application programming interface (API) to advertise available storage capabilities to other devices. Provisioning requests are automatically matched to the best underlying storage to satisfy the stated SLOs by the management server 114. As will be discussed in more detail below, the management server 114 may also include components to determine a profile for an application. In embodiments, the profile may specify settings for one or more storage services provided by the storage system 106, for example. Further, the management server 114 may determine whether required/desired settings for the application are being met by the storage system 106. For example, the management server 114 may periodically, semi-periodically, or non-periodically scan or poll the data server 112 and the aggregates 110 to determine whether storage services provided for the application meet the required/desired storage services. Embodiments are not limited to scanning these particular components of the storage server 106 and other components, not shown, may be scanned to make the determination.

Further, the management server 114 may perform one or more remediation operation to correct non-conforming storage services and provide an indication to one or more devices, such as client 102 or a management client of the result of the remediation operation. In some embodiments, the management server 114 may provide an indication indicating that the storage services provided to an application are conforming to the required storage services.

FIG. 1B illustrates an exemplary embodiment of a system 150 including the storage system 106 as previously discussed above in FIG. 1A. In the illustrated embodiment, the storage system 106 includes a data server 112 and a management server 114 coupled with three aggregates 110-1 through 110-3. Embodiments are not limited in this manner and any number of servers and aggregates may be coupled in a storage system 106.

The management server 114 may include a profile component 152, a storage component 154, and a remediation component 156. The profile component 152 may manage profiles for the storage system 106. A profile may define configurations and settings including SLOs and storage services. The SLOs may be defined into different categories based on objectives of users and may be used as relative priority levels between each other to control resources in the storage system 106. For example, there may be a premium SLO having a highest priority level, a standard SLO having a medium priority level, and a value SLO having the lowest priority level. Settings for one or more storage services may be based on an SLO. In one example, replication transfers for a workload having a premium SLO may be allocated more resources allocated than replication transfers for workloads having a standard SLO or value SLO. In another example, replication transfers for a workload having a standard SLO may be assigned more resources than replication transfers for workloads having a value SLO. Embodiments are not limited to these examples.

The storage services may include auto grow, deduplication, compression, maximum throughput (IOPS and MBS), high availability, disk type, flash acceleration, protocol usage, and replication. The setting for auto grow may determine whether a flexible volume automatically adjusts its size based on need or an adjustment requires user intervention. Deduplication may be set on or off and improves efficiency by locating identical blocks of data and replacing them with references to a single shared block after performing a byte-level verification check. This technique reduces storage capacity requirements by eliminating redundant blocks of data that reside in the same volume. Similarly, compression may be set on or off and reduces the physical capacity required to store data on storage systems by compressing data within a flexible volume (FlexVol® volume) on primary, secondary, and archive storage. Compression compresses regular files, virtual local disks, and LUNs.

In some embodiments, a setting for maximum throughput, Input/Output Operations Per Second (IOPS) and/or megabytes/second (MBS), may be set. Additional settings for high availability, disk type, flash acceleration, protocol, and replication may also be set. One or more of these settings may be set at the storage system level, the aggregate level, flexible volume, and file level. In some instances, a storage service may have different settings at different levels creating a mismatch between settings. Thus, as will be discussed in more detail, embodiments include performing remediation operations to resolve these mismatches.

In some embodiments, the SLO and storage services settings may be defined in a profile. A storage system 106 may have any number of different profiles configured on it. For example, each aggregate 110 may have a profile identifying an SLO and settings for the storage services. In some embodiments, each aggregate 110 may include one or more flexible volumes 165, each capable of having a separate and different profile. Further, each flexible volume 165 may include one or more virtual machines (VM) 160 and each of the VM's 160 may include one or more data structures 170 including virtual volumes, such as files or LUNs. Each VM 160 may have a profile and each data structure 170 may have a profile.

In some embodiments, one or more applications may desire and/or require a particular profile for operation. For example, an application to process critical information may have a profile including a premium SLO and settings for one or more storage services to ensure the information is processed accordingly. Thus, an application (or system administrator) may initially pick a specific, aggregate 110 and/or flexible volume 165 having the proper configuration. If one does not exist, the application (or system administrator) may generate a new flexible volume, for example, to ensure the required profile for the application is met. For any number of reasons one or more settings for the application, settings the aggregate storing the VM(s) 160 for the application, and/or settings the flexible volume 165 for the application may change. Thus, embodiments may include determining when these mismatches occur.

In some embodiments, the profile component 152 may determine a profile for an application and whether the required/desired settings for the application are being met by the storage system 106. For example, the management server 114 may periodically, semi-periodically, or non-periodically scan or poll the data server 112 and/or the aggregates 110 to determine whether storage services provided for the application meet the required/desired storage services. The profile component 152 may scan a specific virtual volume, a specific a flexible volume, or both to determine a profile for an application. In some embodiments, the profile component 152 may first scan the flexible volume 165 for an application and then the data structures 170 for the application. However, embodiments are not limited to this ordering. In some embodiments, the profile component 152 may scan all of the flexible volumes 165 to determine if any mismatches exist between a required profile for an application and the provided profile for the application. Similarly, the profile component 152 may scan all of the data structures 170 or virtual volumes to detect mismatches.

In embodiments, the profile component 152 may receive information indicating settings for each of the storage services configured for the aggregate 110, the flexible volume 165, the VMs 160, and/or the data structures 170 based on the scan performed by the profile component 152. The profile component 152 may communicate the settings to the storage component 154.

The management server 114 may include the storage component 154 which may determine whether the SLO and storage services provided by the storage system 106 are meeting the requirements of applications. For example, the storage component 154 may receive the settings for the storage services provided for the application on the storage system 106 from the profile component 152 and compare those settings with the required settings the application. If the settings match, the storage component 154 may communicate an indication to the remediation component 156 indicating that no remediation operation is required. However, if the settings do not match the required settings for an application, the storage component 154 may communicate information to the remediation component 156 indicating the mismatched settings for the application.

In some embodiments, the management server 114 may include a remediation component 156 capable of performing one or more remediation operations automatically or based on user interaction. The remediation operation may include executing one or instructions to correct any mismatches between required profiles and profiles provided on the storage system 106. These instructions may affect the data server 112, e.g. one or more ESX servers, and one or more aggregates 110 or controllers thereof. The remediation operations may ensure that particular SLOs and storage service settings are met for applications utilizing the storage system 106. In some embodiments, the remediation operation performed may be based and/or dictated by the one or more storage services requiring correction. These and other details will become more apparent in the following description and embodiments are not limited in this manner.

In some embodiments, the remediation operation may include changing a setting for each non-conforming storage service to conform to the profile for the application. By way of example, if a profile for an application requires deduplication off and compression off and both of these settings are enabled on the flexible volume 165 storing the VM 160 for the application, the remediation operation may including turning these settings off on the particular flexible volume 165. Note that by changing the settings at the flexible volume level will cause the settings to be changed for all of the VMs 160 stored in the particular flexible volume 165. For example, if settings are changed for flexible volume 165-1 are changed, all of the VMs 160 in flexible volume 165-1 will be affected. However, VMs 160 in the other flexible volumes 165-2 through 165-6 will not be affected. Thus, changing settings at the flexible volume level may correct non-conforming settings for one application while creating non-conforming settings for another application. Embodiments may include performing additional remediation operations to ensure that settings for all of the applications are conforming to their profiles.

In embodiments, the remediation operation may also include moving one or more data structures, such as a virtual volume associated with the application from a first flexible volume to a second flexible volume, the second flexible volume having settings for storage services conforming to the profile for the application. In one example scenario, a virtual volume may reside in first flexible volume 165-1 where the virtual volume's profile is different and non-conforming with the first flexible volume 165-1 profile. However, the first flexible volume's 165-1 profile is correct and conforms to other VMs 160 and data structures 170 stored in the first flexible volume 165-1. Thus, changing the settings of the first flexible volume 165-1 may not be possible.

In embodiments, the remediation component 158 may determine another flexible volume 165 that does conform to the profile of the data structure 170 and move the data structure 170 to the other flexible volume 165. For example, the second flexible volume 165-2 may conform to the profile of the data structure 170. The remediation component 158 performing the remediation operation may move the data structure 170 from the first flexible 165-1 to the second flexible volume 165-2 on the aggregate 110-1. In some embodiments, more than one data structure 170 may be moved from a flexible volume to a different flexible volume. Further, a VM 160 may also be moved to a different flexible volume.

In some embodiments, the remediation component 158 may also perform a remediation operation by moving a data structure 170 and/or a VM 160 from a flexible volume 165 on a first aggregate 110 to a different aggregate 110. For example, the remediation component 158 may move a data structure 170 from flexible volume 165-1 on aggregate 110-1 to flexible volume 165-5 on aggregate 110-3. Embodiments are not limited to this example. To move a data structure 170 between flexible volumes 165, the remediation component 158 may use one or more instruction or commands, such as a single-file move on demand (SFMOD). Other commands may be used to move more than one file and embodiments are not limited in this manner. Moving a data structure 170 can remediate any of the non-conforming storage services including high availability in a NAS or SAN environment. In some instances, when a data structure 170 or VM 160 are moved between flexible volumes 165, the PE used to access the data structure 170 or VM 160 may change. The data server 112 may notify the application requiring access to the moved data structure 170 or VM 160 of these changes and provide the new PE such that the application may access its information.

The remediation component 158 may also perform a remediation operation by moving a flexible volume from one aggregate 110 to another aggregate 110. More specifically, the remediation component 158 may move a flexible volume associated with the application from a first aggregate to a second aggregate, the second aggregate having settings for the storage services conforming to the profile of the application. By way of example, the flexible volume 165-1 on the first aggregate 110-1 may be moved to the second aggregate 110-2 or a different aggregate. The remediation component 158 may move an entire flexible using a volume move instruction or command specifying the flexible volume to move and the destination for the flexible volume. Embodiments are not limited to this example. As similarly discussed above, when flexible volume 165 is moved, the PE used to access the data structure 170 or VM 160 may change for the application. Thus, the data server 112 may notify the application requiring access to the moved flexible volume 165 and data structures 170 of these changes and provide the new PE such that the application may access its information.

In some embodiments, the remediation component 156 may determine that settings for a flexible volume 165 may not be changed to correct non-conforming issues for an application and a different flexible volumes 165 and/or aggregate 110 does not exist for the one or more data structures 170 to be moved to correct the non-conforming issues. Thus, the remediation component 156 may perform a remediation operation by generating a new flexible volume 165 having a profile that conforms with the profile of one or more data structures 170, e.g. virtual volumes for an application. In some embodiments, the remediation component 156 may only generate a new flexible volume 165 for a group of data structures 170, not for an individual data structure 170. However, embodiments are not limited in this manner.

The remediation component 156 may perform any number of remediation operations to ensure all of the profiles for applications are conforming on a storage system 106. For example, the remediation component 156 may first perform a remediation operation by changing one or more settings on the storage system 106 for non-conforming flexible volumes 165 or data structures 170. However, changing the settings may not cure all of the non-conforming issues. Thus, the remediation component may perform a second remediation component including moving and/or copying a data structure 170 from a first flexible volume 165 to a second flexible volume 165. Similarly, this remediation operation may not ensure all of the non-conforming issues are corrected. Thus, the remediation component 156 may perform a third remediation operation by copying an entire flexible volume 165 from a first aggregate 110 to a second aggregate 110. Embodiments are not limited to only performing three remediation operations and the remediation component 156 may perform any number of remediation operations until all of the non-conforming profiles are cured.

In some embodiments, the remediation component 156 may determine which remediation operation based on the on the storage service that is non-conforming. In other words, certain storage services may only be cured by using particular remediation operation. For example a non-conforming setting for high availability for data structure 170 may require the remediation component 156 to move the data structure 170 from a first flexible volume 165 to another flexible volume 165 because changing the setting on a flexible volume 165 for the data structure 170 may not be possible, and moving the entire flexible volume 165 may not change the high availability setting. Embodiments are not limited to this example. Further and in some embodiments, the remediation operation performed by the remediation component 156 may be a user or administrator selected remediation operation. However, in other instances, the remediation operation may be selected automatically based on which of the settings need correction.

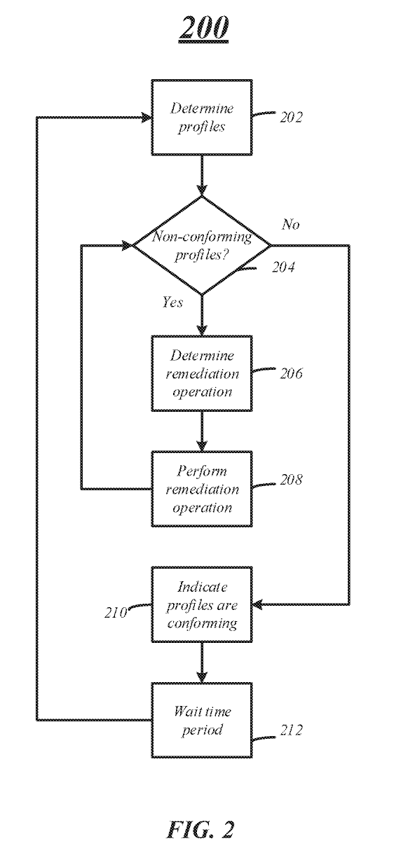

FIG. 2 illustrates one exemplary embodiment of a logic flow 200 for processing information on a storage system and correcting non-conforming profiles. The logic flow 200 may be representative of some or all of the operations executed by one or more embodiments described herein. For example, the logic flow 200 may illustrate operations performed by systems of FIGS. 1A/1B. However, various embodiments are not limited in this manner.

At block 202, one or more profiles for a storage system and applications may be determined. As previously mentioned, a profile may define configurations and settings including SLOs and settings for storage services. The SLOs may be defined into different categories based on objectives of users and may be used as relative priority levels between each other to control resources in the storage system. The storage services may include auto grow, deduplication, compression, maximum throughput (IOPS and MBS), high availability, disk type, flash acceleration, protocol usage, and replication. In embodiments a profile may exist at the aggregate level, the flexible volume level, and the data structure level. The profile for a data structure may indicate the required profile for an application. However, embodiments are not limited in this manner.

The profiles may be determined by performing a scan operation by a management server, e.g. server operating as a VASA provider, on a data server, e.g. one or more ESX servers, and aggregates. The scan may determine a number of profiles configured on the storage system at each storage level, for example. Further and at block 204, the logic flow 200 may include determining whether any mismatches and non-conforming profiles existing on the storage system. For example, the determination may be made by comparing the profiles of data structures for applications with profiles of flexible volumes storing the data structures and/or aggregates storing the data structures. If the profiles match, they may be considered conforming at block 204, and an indication may be communicated to one or more other devices indicating that all of the profiles are conforming on the storage system at block 210.

However, if one or more profiles do not match, they may be considered non-conforming at block 204 and a remediation operation to be performed may be determined at block 206. As discussed above, the remediation operation to be performed may be based on one or more of the storage services that are not conforming in the profiles. Moreover, particular storage services may require a particular remediation operation to be cured. In other instances, an administrator may choose the particular remediation operation to be performed. The remediation operation selected may include changing a setting for a particular storage service, moving one or more data structures associated with an application from a first flexible volume to another flexible volume, and moving a flexible volume associated with an application from a first aggregate to a second aggregate. In some instances, the remediation operation may include generate a new flexible volume for data structures. At block 208, the remediation operation may be performed on the storage system. Blocks 204-208 may be repeated any number of times to cure non-conforming profiles. Once, all of the profiles are conforming, an indication may be communicated at block 210. Further, at block 212 the storage system may wait a period of time in seconds, minutes, hours, days, weeks, and so forth and then the process may be repeated.

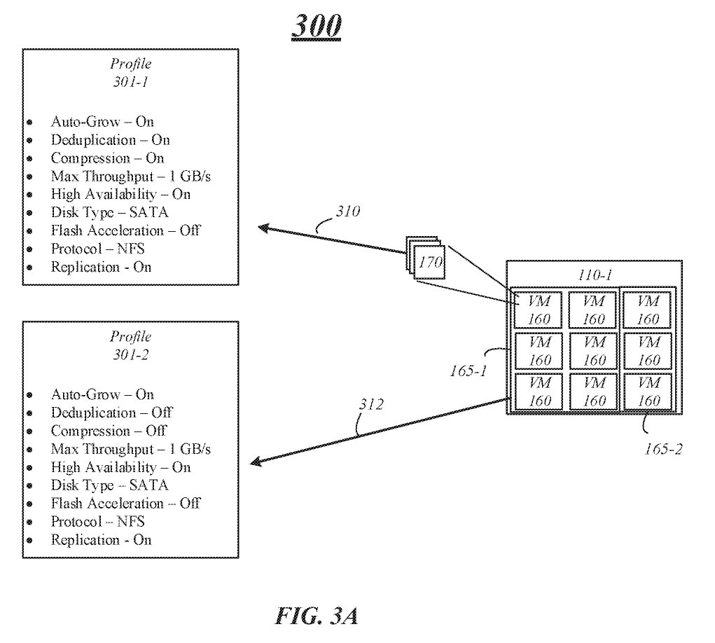

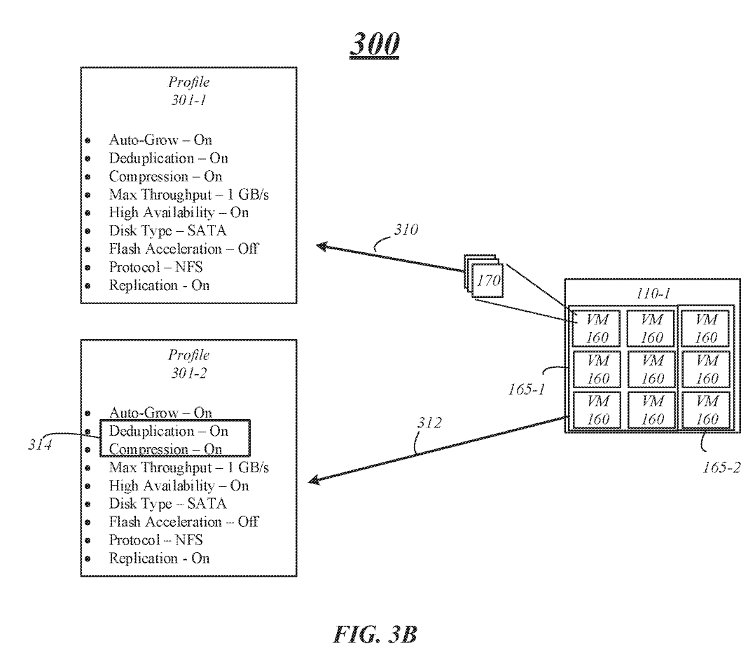

FIGS. 3A/3B illustrate an example first block diagram 300 of remediation operation. In the illustrated embodiment, the remediation operation being performed may change one or more settings for storage services, such that the profiles of the data structures 170 for the application and the flexible volume 165-1 match. In the illustrate example, a first aggregate 110-1 may include two flexible volumes 165-1 and 165-2 each having a number of VMs 160 encapsulating data structures 170, e.g. virtual volumes.

In the illustrated example, an illustrated data structure 170 includes a profile 301-1 as indicated by arrow 310. The profile 301-1 illustrates a number of settings for storage services for the data structure 170 including Auto-Grow—On, Deduplication—On, Compression—On, Max Throughput—1 GB/s, High Availability—On, Disk Type—SATA, Flash Acceleration—Off, Protocol—NFS, and Replication—On.

Further, the first flexible volume 165-1 having the VM 160 and data structure 170 has a profile 301-2 as indicated by arrow 312. Profile 301-2 illustrates a number of settings for the first flexible volume 165-1 including Auto-Grow—On, Deduplication—Off, Compression—Off, Max Throughput—1 GB/s, High Availability—On, Disk Type—SATA, Flash Acceleration—Off, Protocol—NFS, and Replication—On. As illustrated in the example block diagram 300, a mismatch exist between the profiles 301-1 and 301-2. More specifically, the settings for Deduplication and Compression are different between the profiles 301-1 and 301-2. Thus, the required profile and settings for the application utilizing data structure 170 are not being met. The mismatch between profiles 301-1 and 301-2 may be corrected by performing a remediation operation.

FIG. 3B illustrates a result of performing a remediation operation including changing the settings for the non-conforming storage services on the flexible volume 165-1 having the data structure 170. More specifically and as illustrated in block 314, deduplication and compression are now turned on for the flexible volume 165-1. Thus, as can be seen in FIG. 3B the profile 301-1 for the data structure 170 and the profile 301-2 for the first flexible volume 165-1 now match. FIGS. 3A/3B merely represent one example of changing settings to correct non-conforming profiles. In different circumstances, other settings may be changed, for example.

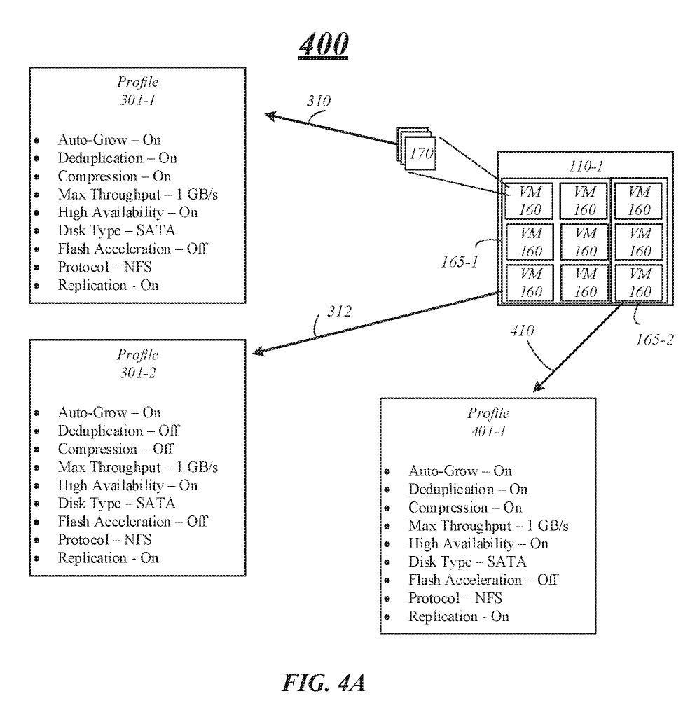

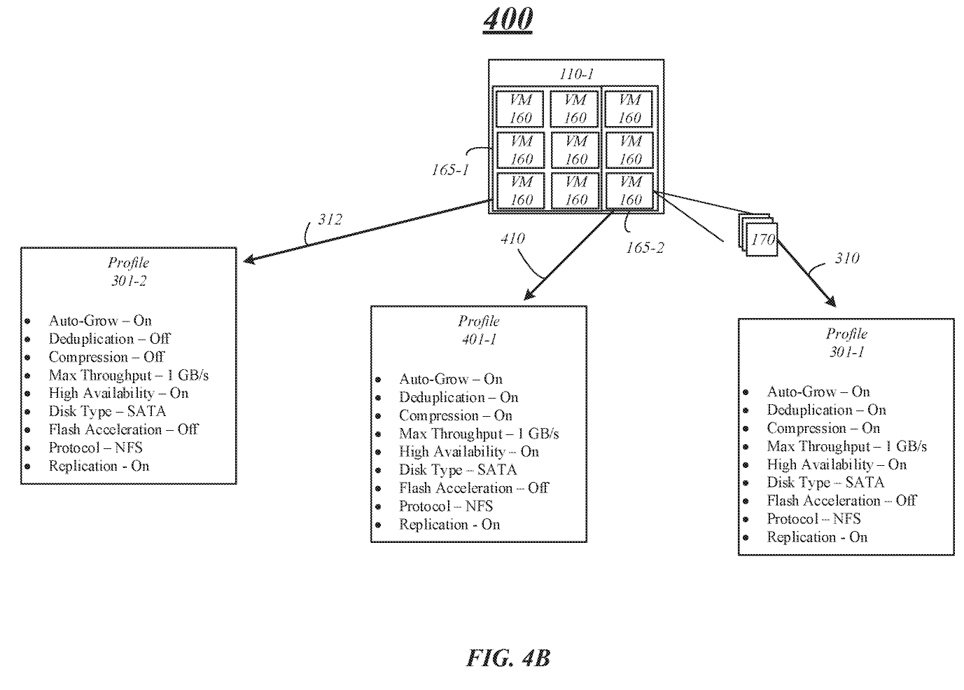

FIGS. 4A/4B illustrate an example second block diagram 400 of a remediation operation. In the illustrated embodiment, the remediation operation being performed may include moving a file(s) among flexible volumes 165 to correct non-conforming profiles. In the illustrate example, a first aggregate 110-1 may include two flexible volumes 165-1 and 165-2 each having a number of VMs 160. In addition, the first flexible volume 165-1 illustrates a data structure 170 encapsulated by one of the VMs 160.

As illustrated in FIG. 4A, the profile 301-1 for the data structure 170 and the profile 301-2 for the first flexible volume 165-1 are non-conforming, e.g. deduplication and compression do not match. Thus, a remediation operation may be performed to cure the non-conforming profiles 301-1 and 301-2. FIG. 4B illustrates the remediation operation which includes moving the data structure 170 from the first flexible volume 165-1 to a second flexible volume 165-2 having a profile 401-1 as indicated by arrow 410. The profile 301-1 for the data structure 170 matches the profile 401-1 for the second flexible volume 165-2. Thus, the remediation operation corrects the non-conforming profiles. FIGS. 4A/4B illustrate a file moving within the same aggregate 110-1. However, embodiments are not limited in this manner and file may be move between aggregates 110 to correct non-conforming profiles.

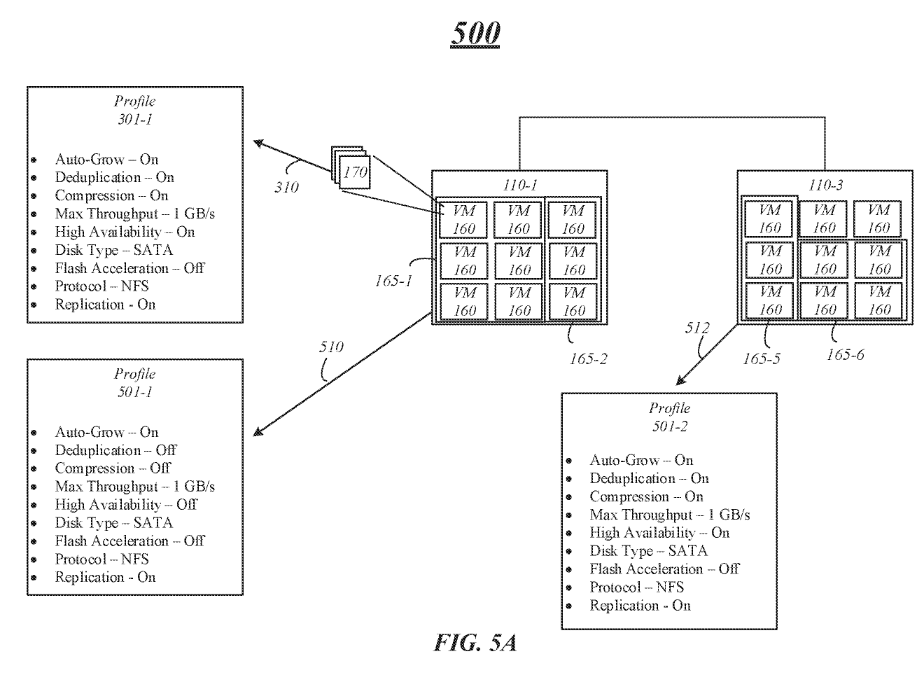

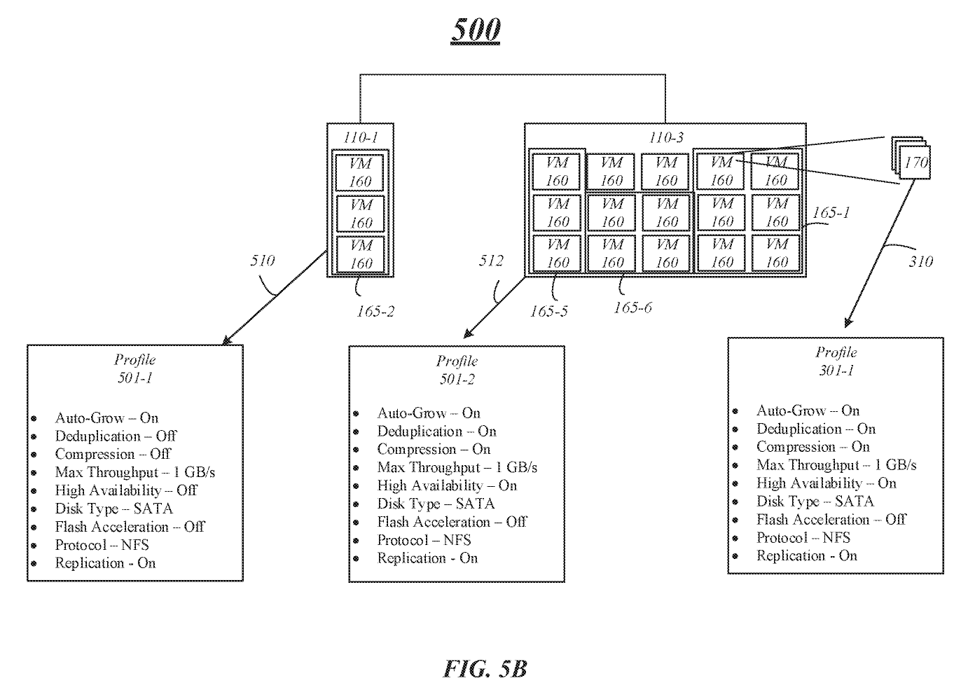

FIGS. 5A/5B illustrate an example third block diagram 500 of a remediation operation. In the illustrated embodiment, the remediation operation being performed may include moving an entire flexible volume from a first aggregate to a second aggregate. In the illustrate example, a first aggregate 110-1 may include two flexible volumes 165-1 and 165-2 and a second aggregate 110-3 may also include two flexible volumes 165-5 and 165-6 each having a number of VMs 160 and data structures 170. For example, the first flexible volume 165-1 includes a VM having data structure 170.

In the illustrated example, the first aggregate 110-1 may have a profile 501-1 as indicated by line 510 and the second aggregate 110-3 may have a profile 501-2 as indicated by line 512. Initially, the first aggregate 110-1 may include the flexible volume 165-1 having the data structure 170 with profile 301-1. The profiles 301-1 and 501-1 do not match, and are non-conforming. For example, profile 301-1 has, in relevant part, Deduplication—On, Compression—On, and High Availability—On and profile 501-1 has in relevant part, Deduplication—Off, Compression—Off, and High Availability—Off. In some instances, one or more of the above-different storage services cannot be changed on the first aggregate 110-1. Thus, embodiments include moving the flexible volume 165-1 including the data structure 170 from a first aggregate 110-1 to a second aggregate 110-3 that may support all of the storage services using a volume move operation.

FIG. 5B illustrates the flexible volume 165-1 being moved from the first aggregate 110-1 to a different aggregate 110-3 which includes a profile 501-2 that supports the profile of the data structure 170 in the flexible volume 165-1. More specifically, the profile 501-2 for the second aggregate 110-3 as indicated by line 512 includes Deduplication—On, Compression—On, and High Availability—On. The remaining storage services in profile 501-2 also match the profile 301-1. Thus, the profile 501-2 is conforming to the profile 301-1 for the data structure 170 and associated application. FIGS. 3A-5B are provided as examples and embodiments are not limited in this manner.

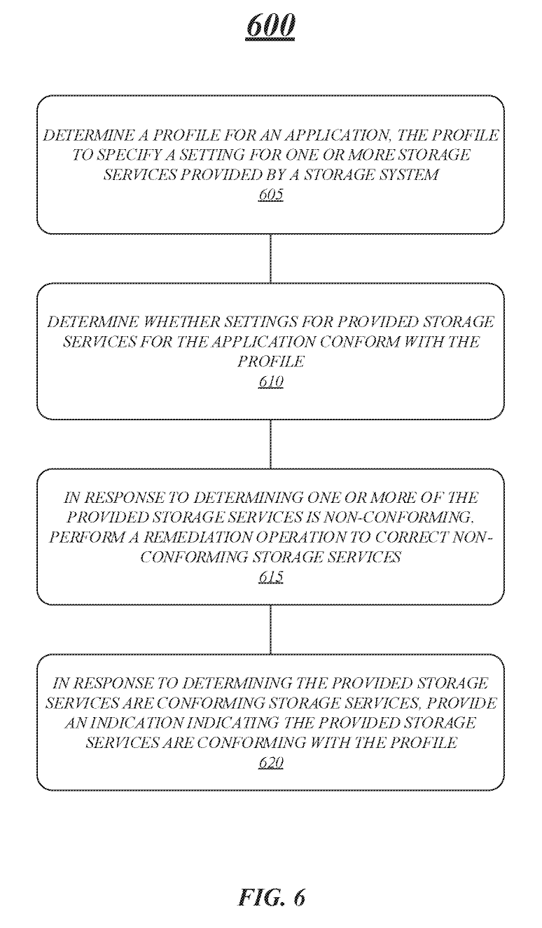

FIG. 6 illustrates an embodiment of logic flow 600. The logic flow 600 may be representative of some or all of the operations executed by one or more embodiments described herein. For example, the logic flow 600 may illustrate operations performed by systems of FIGS. 1A-5B. However, various embodiments are not limited in this manner.

In the illustrated embodiment shown in FIG. 6, the logic flow 600 may include determining a profile for an application at block 605, the profile to specify a setting for one or more storage services provided by a storage system. In some embodiments, the profile may be determined by a management server including one or more components performing a scan, poll or read operation of a storage system including data servers and aggregates. In some embodiments, the profile for the application may be determined or based on the profile of a data structure, such virtual volume for the application. Further, the profile may indicate one or more settings for storage services that are required by the application and associated data structure. In some instances, these settings may be based on SLOs selected or defined for the application.

At block 610, the logic flow may include determining whether settings for provided storage services for the application conform to the profile. The provided storage services may be determined during the scan, poll, or read operation performed by the management server and based on the profiles of the aggregate and flexible volume on which the application and data structure are stored. The management server may determine whether the provided storage services are the same or match the required storage services as specified by the profile associated with the data structure and application. If the settings are the same, then the provided storage services conform to the profile for the application. However, if the settings do not match the required storage services, then they do not conform.

In some embodiments, at block 615, the logic flow 600 may include, in response to determining one or more of the provided storage services is non-conforming, performing a remediation operation to correct non-conforming storage services. The remediation operation may include changing a setting for each non-conforming storage service to conform to the profile for the application. In another example, the remediation operation may include moving one or more data structures associated with the application from a first flexible volume to a second flexible volume, the second flexible volume having settings for storage services conforming to the profile. In a third example, the remediation operation may include moving a flexible volume associated with the application from a first aggregate to a second aggregate, the second aggregate having settings for the storage services conforming to the profile. Embodiments are not limited to these examples. For example, the remediation may include generate a new volume for a group of data structures having the same storage service requirements.

In embodiments, at block 620, the logic flow 600 may include, in response to determining the provided storage services are conforming storage services, provide an indication indicating the provided storage services are conforming to the profile.

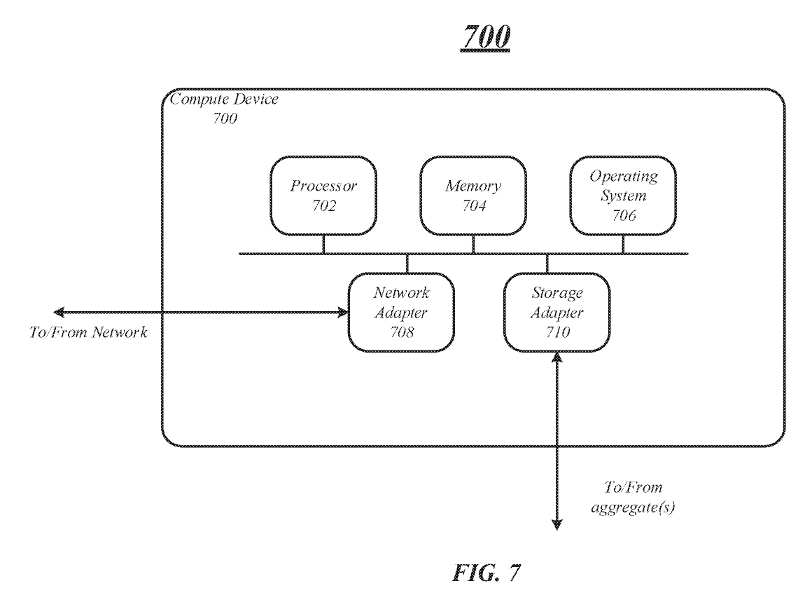

FIG. 7 illustrates an exemplary embodiment of hardware architecture of a computing device 700. In some embodiments, computing device 700 may be the same or similar as one of the servers of the storage system 106, such as the management server 114 and data server 112. Computing device 700 may include processor 702, memory 704, storage operating system 706, network adapter 708 and storage adapter 710. In various embodiments, the components of computing device 700 may communicate with each other via one or more interconnects, such as one or more traces, buses and/or control lines.

Processor 702 may be one or more of any type of computational element, such as but not limited to, a microprocessor, a processor, central processing unit, digital signal processing unit, dual core processor, mobile device processor, desktop processor, single core processor, a system-on-chip (SoC) device, complex instruction set computing (CISC) microprocessor, a reduced instruction set (RISC) microprocessor, a very long instruction word (VLIW) microprocessor, or any other type of processor or processing circuit on a single chip or integrated circuit. In various embodiments, computing device 700 may include more than one processor.

In one embodiment, computing device 700 may include a memory unit 704 to couple to processor 702. Memory unit 704 may be coupled to processor 702 via an interconnect, or by a dedicated communications bus between processor 702 and memory unit 704, which may vary as desired for a given implementation. Memory unit 704 may be implemented using any machine-readable or computer-readable media capable of storing data, including both volatile and non-volatile memory. In some embodiments, the machine-readable or computer-readable medium may include a non-transitory computer-readable storage medium, for example. The embodiments are not limited in this context.

The memory unit 704 may store data momentarily, temporarily, or permanently. The memory unit 704 may store instructions and data for computing device 700. The memory unit 704 may also store temporary variables or other intermediate information while the processor 702 is executing instructions. The memory unit 704 is not limited to storing the above discussed data; the memory unit 704 may store any type of data. In various embodiments, memory 704 may store or include storage operating system 706

In various embodiments, computing device 700 may include storage operating system 706 to control storage operations on the computing device 700. In some embodiments, storage operating system 706 may be stored in memory 704 or any other type of storage device, unit, medium, and so forth. The storage operating system 706 may implement a write-anywhere file system that cooperates with virtualization modules to “virtualize” the storage space provided on the storage arrays and storage devices. The file system may logically organize the information as a hierarchical structure of named directories and files on the disks. Each “on-disk” file may be implemented as set of disk blocks configured to store information, such as data, whereas the directory may be implemented as a specially formatted file in which names and links to other files and directories are stored. The virtualization modules allow the file system to further logically organize information as a hierarchical structure of logical data blocks on the disks that are exported as logical unit numbers (LUNs).

The network adapter 708 may include the mechanical, electrical and signaling circuitry needed to connect the computing device 700 to one or more hosts and other storage systems over a network, which may include a point-to-point connection or a shared medium, such as a local area network.

In various embodiments, the storage adapter 710 cooperates with the operating system 706 executing on the computing device 700 to access information requested by a host device, guest device, another storage system and so forth. The information may be stored on any type of attached array of writable storage device media such as video tape, optical, DVD, magnetic tape, bubble memory, electronic random access memory, micro-electro mechanical and any other similar media adapted to store information, including data and parity information. Further, the storage adapter 710 includes input/output (I/O) interface circuitry that couples to the disks over an I/O interconnect arrangement, such as a conventional high-performance, FC serial link topology.

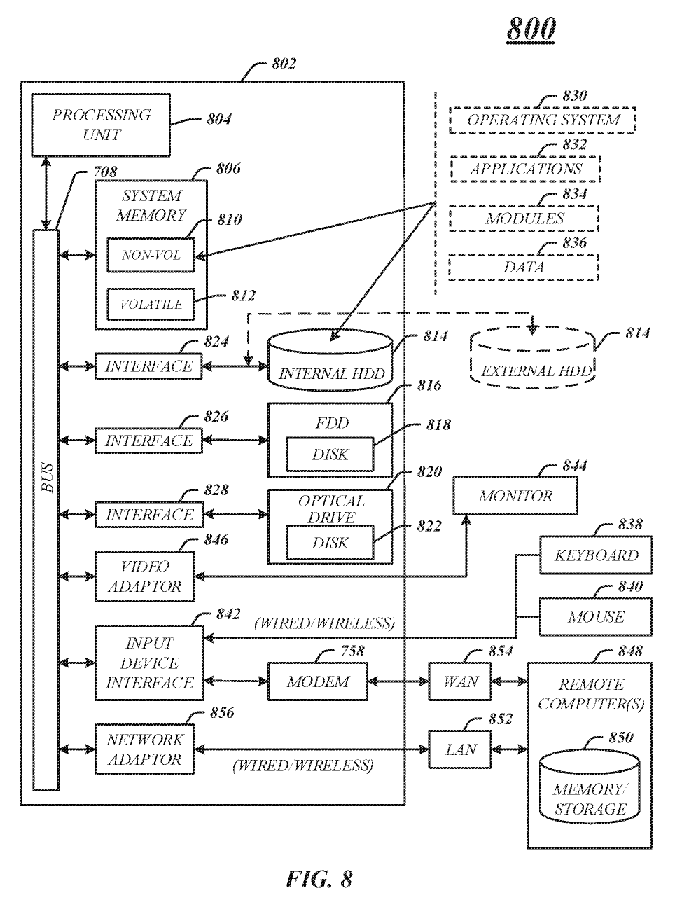

FIG. 8 illustrates an embodiment of an exemplary computing architecture 800 suitable for implementing various embodiments as previously described. In one embodiment, the computing architecture 800 may include or be implemented as part of computing system, such as any of the previously discussed systems.

As used in this application, the terms “system” and “component” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 includes a processing unit 804, a system memory 806 and a system bus 808. The processing unit 804 can be any of various commercially available processors.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 800 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of the system 100.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the storage system 100, 125, 150, and 175 as previously described with reference to FIGS. 1-8 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a processor;
a machine-readable medium comprising program code executable by the processor to cause the apparatus to determine profiles for applications that access virtual volumes encapsulated by virtual machines assigned to flexible volumes of a storage system, wherein the flexible volumes are on groups of storage devices of the storage system and each of the profiles specify settings for storage services for a respective one of the applications;
to scan the flexible volumes to determine whether provided storage services settings of the flexible volumes conform to the profiles of the applications of the flexible volumes, wherein the program code to scan the flexible volumes to determine whether storage services settings of the flexible volumes conform to the profiles of the applications comprises the program code executable by the processor to cause the apparatus to determine, for each virtual machine on each flexible volume, whether a storage service setting of the flexible volume does not conform to the corresponding storage service setting indicated for the profile of the application that accesses the virtual volume encapsulated by the virtual machine; and
in response to determining a non-conforming storage service setting, to perform one or more remediation operations to correct non-conforming storage services settings, wherein the program code to perform the one or more remediation operations comprises the program code executable by the processor to cause the apparatus to either move the virtual volume accessed by the application corresponding to the non-conforming storage service setting to a flexible volume with conforming storage services settings or create a new flexible volume with conforming storage services settings.

2. The apparatus of claim 1, the storage services including auto grow, deduplication, compression, maximum throughput, high availability, disk type, flash acceleration, protocol usage, and replication.

3.-20. (canceled)

21. The apparatus of claim 1, wherein the program code to determine profiles for applications comprises program code executable by the processor to cause the apparatus to scan the virtual volumes to determine the profiles of the applications corresponding to the virtual volumes.

22. The apparatus of claim 1, wherein the program code to determine whether storage services settings of the flexible volumes conform to the profiles of the applications comprises the program code executable by the processor to cause the apparatus to determine, for each virtual machine assigned to each flexible volume, whether each storage service setting of a service level objective of the virtual machine matches each storage service setting indicated in the profile of the application on the virtual machine.

23. One or more non-transitory machine-readable media comprising program code for automatically ensuring conformance of storage services settings for applications, the program code comprising instructions to:
determine profiles for applications that access virtual volumes encapsulated by virtual machines assigned to flexible volumes of a storage system, wherein the flexible volumes are on groups of storage devices of the storage system and each of the profiles indicates settings for storage services for a respective one of the applications;
scan the flexible volumes to determine whether storage services settings of the flexible volumes conform to the profiles of the applications of the flexible volumes, wherein the instructions to scan the flexible volumes to determine whether storage services settings of the flexible volumes conform to the profiles of the applications comprise instructions to determine, for each virtual machine of each flexible volume, whether a storage service setting of the flexible volume does not conform to the corresponding storage service setting indicated for the profile of the application that accesses the virtual volume encapsulated by the virtual machine; and
in response to a determination of a non-conforming storage service setting, move the virtual volume accessed by the application corresponding to the non-conforming storage service setting to one of the flexible volume with conforming storage services settings or create a new flexible volume with conforming storage services settings.

24. The one or more non-transitory machine-readable media of claim 23, wherein the instructions to determine profiles for applications comprise instructions to scan the virtual volumes to determine the profiles of the applications corresponding to the virtual volumes.

25. The one or more non-transitory machine-readable media of claim 23, wherein the instructions to determine whether storage services settings of the flexible volumes conform to the profiles of the applications comprise instructions to determine, for each virtual machine assigned to each flexible volume, whether each storage service setting of a service level objective of the virtual machine matches each storage service setting indicated in the profile of the application on the virtual machine.

26. The one or more non-transitory machine-readable media of claim 23, wherein the storage services include multiple of auto grow, deduplication, compression, maximum throughput, high availability, disk type, flash acceleration, protocol usage, and replication.

27. A method comprising:
determining profiles for applications that access virtual volumes encapsulated by virtual machines assigned to flexible volumes of a storage system, wherein the flexible volumes are on groups of storage devices of the storage system and each of the profiles indicates settings for storage services for a respective one of the applications;
scanning the flexible volumes to determine whether storage services settings of the flexible volumes conform to the profiles of the applications of the flexible volumes, wherein scanning the flexible volumes to determine whether storage services settings of the flexible volumes conform to the profiles of the applications comprises determining, for each virtual machine of each flexible volume, whether a storage service setting of the flexible volume does not conform to the corresponding storage service setting indicated for the profile of the application that accesses the virtual volume encapsulated by the virtual machine; and
in response to a determination of a non-conforming storage service setting, moving the virtual volume accessed by the application corresponding to the non-conforming storage service setting to one of the flexible volumes with conforming storage services settings or creating a new flexible volume with conforming storage services settings.

28. The method of claim 27, wherein determining profiles for applications comprises scanning the virtual volumes to determine the profiles of the applications corresponding to the virtual volumes.

29. The method of claim 27, wherein determining whether storage services settings of the flexible volumes conform to the profiles of the applications comprises determining, for each virtual machine assigned to each flexible volume, whether each storage service setting of a service level objective of the virtual machine matches each storage service setting indicated in the profile of the application on the virtual machine.

30. The method of claim 27, wherein the storage services include multiple of auto grow, deduplication, compression, maximum throughput, high availability, disk type, flash acceleration, protocol usage, and replication.
